(19) United States
(12) Patent Application Publication
(10) Pub. No.: US 2024/0170645 A1
(43) Pub. Date: May 23, 2024

(54) MIXTURE OF ACTIVE MATERIALS FOR CATHODE OF A LITHIUM-ION CELL

(71) Applicant: SAFT, Levallois-Perret (FR)

(72) Inventors: Lucille GAL, EYSINES (FR); Michelle BAUDRY, EYSINES (FR)

(73) Assignee: SAFT, Levallois-Perret (FR)

(21) Appl. No.: 18/283,982

(22) PCT Filed: Apr. 8, 2022
(86) PCT No.: PCT/EP2022/059488

§ 371 Date: Sep. 25, 2023

(30) Foreign Application Priority Data
Apr. 22, 2021 (FR) FR21 04 226

(51) Int. Cl. H01M 4/36; H01M 4/02; H01M 4/505; H01M 4/525; H01M 4/58; H01M 10/0525; H01M 10/44; H01M 10/48

(52) U.S. Cl. CPC H01M 4/364; H01M 4/505; H01M 4/525; H01M 4/5825; H01M 10/0525; H01M 10/44; H01M 10/48; H01M 2004/021

(57) ABSTRACT

The invention relates to a mixture comprising: —more than 50 to 99% by weight of a lithium phosphate of manganese and iron—1 to less than 50% by weight of at least one lithium oxide of nickel, manganese and cobalt or at least one lithium oxide of nickel, cobalt and aluminium, or of a mixture of these two oxides, these two lithium oxides being rich in nickel. This mixture can be used as active material of the cathode of a lithium-ion electrochemical element. The charging profile of the element has a plateau indicating the end of charging.

### TECHNICAL FIELD OF THE INVENTION

The technical field of the present invention is that of active materials intended to be used in the cathode of a lithium-ion-type electrochemical cell, also called lithium-ion cell. The technical field is also that of methods for detecting the end of charge of lithium-ion cells whose cathode active material comprises a lithium phosphate of at least one transition metal.

### BACKGROUND OF THE INVENTION

Lithium-ion-type electrochemical cells including a cathode whose active material is based on lithium phosphate of at least one transition metal are known from the state of the art. A lithium phosphate of at least one transition metal typically has the formula LiMPO₄ where M represents at least one transition metal, for example Mn or Fe or Mn combined with Fe. Such cells have a weight capacity less than that of cells whose cathode comprises an active material which is a lithium oxide of at least one transition metal of formula LiMO₂ where M represents at least one transition metal. However, they offer a higher safety in use due to the fact that lithium phosphates of transition metals are more thermally stable than lithium oxides of transition metals. Determining the state of charge of a cell whose cathode comprises a lithium phosphate of at least one transition metal is difficult. Indeed, such an cell has for states of charge comprised between 30 and 80% a charging profile called “flat” charging profile. Charging profile means the curve representing the variation of the voltage of the cell as a function of time during charging. In the range of states of charge comprised between 30 and 80%, the voltage of the cell increases very little, so that it is difficult to establish a correspondence between the voltage of the cell and its state of charge. In addition, when approaching the end of charge, that is to say for a state of charge comprised between about 95 and 100%, the voltage of the cell increases suddenly. Indeed, the dilithiation of almost of the lithium present in the lithium phosphate causes a sudden rise in voltage. This sudden rise does not allow to warn a user sufficiently early of the imminence of an overcharge. The voltage of the cell can quickly reach high values. Prolonged exposure of the cell to overcharging causes electrolyte degradation and reduced cell life.

An example of the charging profile of a cell whose cathode comprises a lithium phosphate of at least one transition metal is shown in FIG. 1. There is a first phase ranging from the 0% of state of charge to 30% during which the voltage increases rapidly, then a second phase going from 30% up to about 80% of state of charge during which the voltage hardly increases and finally a third phase going from about 95% to 100% during which the voltage increases very rapidly.

Methods for detecting the end of charge have been researched to allow to detect the imminence of the end of charge sufficiently early. Mention may be made, for example, of document EP-A-2309615. In this document, the voltage is measured periodically and when a sudden rise in the voltage is detected, charging is interrupted or the intensity of the charging current is reduced.

A way to make the detection of the end of charge even safer by signalling even more precisely the imminence of the end of charge, is sought.

### SUMMARY OF THE INVENTION

To this end, the present invention provides a mixture comprising:
more than 50 to 99% by weight of a lithium phosphate of manganese and iron of formula: LiₓMn_{1-y-z}Fe_{y}M_{z}PO₄ where 0.8≤x≤1.2; 0.5≤1−y−z<1; 0<y≤0.5; 0≤z≤0.2 and M is at least one element selected from the group consisting of B, Mg, Al, Si, Ca, Ti, V, Cr, Co, Ni, Cu, Zn, Y, Zr, Nb and Mo;
1 to less than 50% by weight of at least one lithium oxide of nickel selected from:
i) a lithium oxide of nickel, manganese and cobalt of formula Li_{w}(NiₓMn_{y}Co_{z}Mₜ)O₂ where 0.9≤w≤1.1; 0.80≤x; 0<y; 0<z; 0≤t; M being at least one element selected from the group consisting of Al, B, Mg, Si, Ca, Ti, V, Cr, Fe, Cu, Zn, Y, Zr, Nb, W, Mo, Sr, Ce, Ta, Ga, Nd, Pr, La;
ii) a lithium oxide of nickel, cobalt and aluminum of formula Li_{w}(NiₓCo_{y}Al_{z}Mₜ)O₂ where 0.9≤w≤1.1; 0.83≤x; 0<y; 0<z; O≤t; M being at least one element selected from the group consisting of B, Mg, Si, Ca, Ti, V, Cr, Mn, Fe, Cu, Zn, Y, Zr, Nb, W, Mo, Sr, Ce, Ga, Ta, Nd, Pr, La, and
iii) a mixture of said lithium oxide of nickel, manganese and cobalt with said lithium oxide of nickel, cobalt and aluminum.

It has been surprisingly discovered that the incorporation into the lithium phosphate of a nickel-rich lithium oxide allowed to obtain a mixture of active materials which, when used in the cathode of a lithium-ion electrochemical cell, can be used to detect the imminence of the end of charge of the cell, thus to avoid a beginning of overcharge. Indeed, the charging profile of the cell has a plateau indicating the end of charge of the cell. This plateau appears for a state of charge close to 90-95%. The appearance of the plateau results in a slowing down of the increase in voltage. It can be detected by analyzing periodically or at predetermined instants the variation in the voltage of the cell over time. After detection of the plateau, a signal indicating the imminence of the end of charge can be sent to a user.

According to one embodiment, said at least one lithium oxide of nickel is monocrystalline.

According to one embodiment, said at least one lithium oxide of nickel is in the form of particles whose size distribution is characterized by a volume median diameter Dv₅₀ less than or equal to 7 μm, preferably ranging from 2 to 6 μm, the median diameter being measured on particles not forming part of an agglomerate of particles.

According to one embodiment, the mixture comprises:
from 60 to 90% by weight of lithium phosphate of manganese and iron;
from 10 to 40% by weight of said at least one lithium oxide of nickel.

According to one embodiment, the mixture comprises:
from 70 to 80% by weight of lithium phosphate of manganese and iron;
from 20 to 30% by weight of said at least one lithium oxide of nickel.

According to one embodiment, in the lithium oxide of nickel, the index x of the nickel ranges from 0.84 to 0.90.

According to one embodiment, in the lithium oxide of nickel, the index x of the nickel is less than or equal to 0.98 or less than or equal to 0.90.

According to one embodiment, in the lithium phosphate of manganese and iron, the index 1−y−z of manganese ranges from 0.6 to less than 1.

The invention also relates to an electrochemical cell comprising:
at least one anode,
at least one cathode comprising the mixture as described above.

Finally, the object of the invention is a method for detecting the end of charge of a lithium-ion electrochemical cell, said method comprising the steps of:
a) providing an electrochemical cell as described above,
b) charging the cell,
c) for a state of charge of the cell greater than approximately 70%, or greater than approximately 80%, or greater than or equal to 85%, or greater than or equal to 90%, calculating at periodic or predetermined instants the value of the derivative of the voltage with respect to time dV/dt,
d) sending a signal indicating the imminence of the end of charge if the value of the derivative dV/dt is lower than a predetermined threshold.

### BRIEF DESCRIPTION OF THE DRAWINGS

Embodiments of the invention are described below in more detail with reference to the attached FIGURES.

FIG. 1 shows the charging profile of a cell whose cathode comprises as electrochemically active material only a lithium phosphate of manganese and iron.

FIG. 2 shows the charging profiles of the cells prepared in the examples.

FIG. 3 is a magnification of the charging profiles shown in FIG. 2.

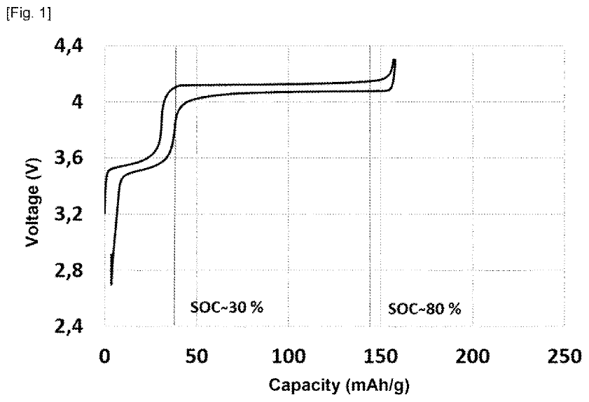

### DESCRIPTION OF EMBODIMENTS OF THE INVENTION

According to the invention, the addition to the lithium phosphate of at least one nickel-rich lithium oxide allows to obtain a mixture whose charging profile has a plateau when approaching the end of charge of the cell. The term “nickel-rich” denotes, in the following, a stoichiometric nickel index greater than or equal to 0.80 for the lithium oxide of nickel, manganese and cobalt and greater than or equal to 0.83 for the lithium oxide of nickel, cobalt and aluminum. According to the invention, the proportion of the lithium oxide ranges from 1 to less than 50% of the weight of all the active materials present in the cathode. It can range from 5 to 40% or from 10 to 30% or from 15 to 25% of the weight of all the active materials present in the cathode.

The lithium oxide of nickel is said to be lamellar because it consists of a stack of sheets of formula MO₂, where M designates one or more transition elements. Each sheet is made up of the combination of octahedra MO₆ sharing their edges. The center of each octahedron is occupied by a transition element M and the six vertices of the octahedron are occupied by an oxygen atom. The lithium atom is intercalated between the MO₂ sheets.

During the charging of the electrochemical cell, it is deintercalated from the sheets. During the discharging of the cell, it is reintercalated between the sheets.

The nickel of the lithium oxide can be combined with manganese, cobalt, and optionally one or more chemical elements to give the compound of formula Li_{w}(NiₓMn_{y}Co_{z}Mₜ)O₂ abbreviated NMC where 0.9≤w≤1.1; 0.80≤x; 0<y; 0<z; 0≤t; M being at least one element selected from the group consisting of Al, B, Mg, Si, Ca, Ti, V, Cr, Fe, Cu, Zn, Y, Zr, Nb, W, Mo, Sr, Ce, Ta, Ga, Nd, Pr and La. Preferred NMC compounds 1)-3) satisfy the following criteria:
1) 0.9≤w≤0.1; 0.80≤x; 0<y<0.15; 0<z<0.15 and t=0. In this embodiment, x may be at least equal to 0.82 or at least equal to 0.84 or at least equal to 0.86 or at least equal to 0.88 or at least equal to 0.90.
2) 0.9≤w≤1.1; 0.84≤x; 0<y≤0.10; 0<z≤0.10 and t=0. In this embodiment, x can be at least equal to 0.86 or at least equal to 0.88 or at least equal to 0.90.
3) w=1; 0.84≤x; 0<y≤0.10; 0<z≤0.10 and t=0. In this embodiment x can be at least equal to 0.85 or at least equal to 0.86 or at least equal to 0.88 or at least equal to 0.90. Nickel-rich NMC-type compounds are, for example, LiNi_{0.84}Mn_{0.08}Co_{0.08}O₂ and LiNi_{0.87}Mn_{0.06}Co_{0.07}O₂, LiNi_{0.89}Mn_{0.06}Co_{0.05}O₂. Several NMC-type compounds may be present in the cathode.

The nickel of the lithium oxide can be combined with cobalt, aluminum and possibly one or more chemical elements to give the compound of formula Li_{w}(NiₓCo_{y}Al_{z}Mₜ)O₂ abbreviated NCA where 0.9≤w≤1.1; 0.83≤x; 0<y; 0<z; 0≤t; M being at least one element selected from the group consisting of B, Mg, Si, Ca, Ti, V, Cr, Mn, Fe, Cu, Zn, Y, Zr, Nb, W, Mo, Sr, Ce, Ga, Ta, Nd, Pr and La. Preferred NCA compounds 1)-3) satisfy the following criteria:
1) 0.9≤w≤1.1; 0.83≤x; 0<y<0.15; 0<z<0.15 and t=0. In this embodiment, x can be at least equal to 0.84 or at least equal to 0.86 or at least equal to 0.88 or at least equal to 0.90 or at least equal to 0.92.
2) 0.9≤w≤1.1; 0.84≤x; 0<y≤0.10; 0<z≤0.10 and t=0. In this embodiment, x can be at least equal to 0.86 or at least equal to 0.88 or at least equal to 0.90.
3) w=1; 0.84≤x; 0<y≤0.10; 0<z≤0.10 and t=0. In this embodiment, x can be at least equal to 0.85 or at least equal to 0.86 or at least equal to 0.88 or at least equal to 0.90. Nickel-rich NCA-type compounds are for example LiNi_{0.84}Co_{0.08}Al_{0.08}O₂, LiNi_{0.85}Co_{0.10}Al_{0.05}O₂, LiNi_{0.87}Co_{0.06}Al_{0.07}O₂, LiNi_{0.89}Co_{0.06}Al_{0.05}O₂. Several NCA-type compounds may be present in the cathode. A mixture of one or more NMC-type compounds and one or more NCA-type compounds can be used in the cathode.

The lithium oxide of nickel can be a monocrystal or a polycrystal. A monocrystal is a solid made up of a single crystal, formed from a single seed. A polycrystal is a solid made up of a set of crystals of varying size, shape and orientation, separated by grain boundaries. Preferably, the lithium oxide of nickel is a monocrystal. It has in fact been discovered that when the lithium oxide of nickel is in the form of a monocrystal, the electrochemical cell has a better cycle life. A procedure given by way of indication for the manufacture of a monocrystal of the lithium oxide of nickel, manganese and cobalt is as follows. A NiₓMn_{y}Co_{z}Mₜ(OH)₂ precursor is prepared via a coprecipitation method. For this purpose, aqueous solutions are prepared from a nickel salt, a manganese salt, a cobalt salt and a salt of the element M. Salts which are highly soluble in aqueous medium are chosen. It may for example be NiSO₄·6H₂O, MnSO₄·5H₂O, CoSO₄·7H₂O. The amounts of salts are calculated to correspond to the Ni:Mn:Co:M molar ratios of x:y:z:t. The aqueous solutions are simultaneously introduced into a continuously stirred reactor under a nitrogen atmosphere. During this time, a solution of NaOH (for example 5 mol·L⁻¹), used as a precipitation agent, and a solution of NH₃·H₂O (for example 4 mol·L⁻¹), used as a chelating agent, are introduced separately in the reactor. The temperature, for example 50° C., the pH value, for example 11.5 and the stirring speed of the solution, for example 500 rpm, are controlled and kept constant. NiₓMn_{y}Co_{z}Mₜ(OH)₂ particles are obtained by washing, filtration and drying in a vacuum oven at 110° C. overnight. Then this precursor is mixed with LiOH·H₂O.

The molar amount of lithium is in slight excess compared to the total molar amount of the elements Ni, Mn, Co and M. The excess lithium is intended to compensate for the loss of lithium during the sintering method. Then, the mixture is annealed at about 500° C. for about 5 hours, then calcined at about 850° C. for about 10 hours under an oxygen atmosphere to finally obtain the monocrystal of Li_{w}NiₓMn_{y}CO_{z}MₜO₂. The preparation of a monocrystal of Li_{w}NiₓCo_{y}Al_{z}MₜO₂ is carried out in a similar manner. The aluminum element is supplied in the form of an aqueous solution prepared from aluminum salts which are soluble in an aqueous medium. It can be sulfate or nitrate or aluminum chloride.

Lithium oxide of nickel is used in the cathode formulation in the form of a powder of particles. In the case of a monocrystal, the size distribution of the particles is characterized by a median volume diameter Dv₅₀ less than or equal to 7 m, or ranging from 2 to 6 μm, the median diameter being measured on particles not forming part of an agglomerate of particles. In the case of a polycrystal, the size distribution of the agglomerate of crystals is characterized by a median volume diameter Dv₅₀ greater than or equal to 8 μm, ranging for example from 8 to 12 μm. The term “median diameter Dv₅₀ equal to X μm” means that 50% of the volume of the nickel lithium oxide particles is made up of particles having an equivalent diameter less than X μm, and 50% of the volume of the nickel lithium oxide particles is made up of particles with an equivalent diameter greater than X μm. The term “equivalent diameter of a particle” designates the diameter of a sphere having the same volume as this particle. The measurement of the particle size can be carried out by the technique of laser diffraction granulometry using an apparatus Malvern Mastersizer 2000.

The lithium phosphate of manganese iron has the formula LiₓMn_{1-y-z}Fe_{y}M_{z}PO₄ (LMFP), where M is at least one element selected from the group consisting of B, Mg, Al, Si, Ca, Ti, V, Cr, Co, Ni, Cu, Zn, Y, Zr, Nb and Mo, with 0.8≤x≤1.2; 0≤y≤0.5; 0≤z≤0.2.

In one embodiment, 0.7≤1-y-z≤0.9 or 0.75≤1-y-z≤0.8.

The stoichiometric index y of iron can be strictly less than 0.5 or less than or equal to 0.45 or less than or equal to 0.40 or less than or equal to 0.30 or less than or equal to 0.20. It may be greater than or equal to 0.05 or greater than or equal to 0.10 or greater than or equal to 0.20 or greater than or equal to 0.30 or greater than or equal to 0.40.

In one embodiment, 0.15≤y≤0.25.

Typical formulas of lithium manganese iron phosphate are LiMn_{0.8}Fe_{0.2}PO₄, LiMn_{0.7}Fe_{0.3}PO₄, LiMn_{2/3}Fe_{1/3}PO₄ and LiMn_{0.5}Fe_{0.5}PO₄.

The lithium manganese iron phosphate can be coated with a layer of a conductive material, such as carbon.

According to the invention, the proportion of lithium phosphate ranges from more than 50% to 99%, or from 55 to 90% or from 60 to 80% or from 65 to 75% of the weight of all the active materials of the cathode. The presence of a majority of lithium phosphate gives the electrochemical cell good thermal stability.

A preferred mixture of active materials comprises:
from 60 to 90% or from 70 to 80% by weight of lithium phosphate,
from 10 to 40% or from 20 to 30% by weight of at least one monocrystalline lithium oxide of nickel.

### Preparation of the Cathode

The composition of cathode active material designates the set of compounds which cover the current collector of the cathode on at least one of its faces. Generally, this composition comprises:
all the electrochemically active materials, that is to say said at least one lithium oxide of nickel, the lithium phosphate of manganese and iron described above and optionally one or more other electrochemically active materials;
one or more binders; and
one or more electronic conductive materials.

The function of the binder is to reinforce the cohesion between the particles of active material as well as to improve the adhesion of the mixture according to the invention to the current collector. The binder may be one or more of the following compounds: polyvinylidene fluoride (PVDF) and its copolymers such as polyvinylidene fluoride-co-hexafluoropropylene (PVDF-HFP), polytetrafluoroethylene (PTFE) and its copolymers, polyacrylonitrile (PAN), poly(methyl)- or (butyl)methacrylate, polyvinyl chloride (PVC), poly(vinyl formal), polyester, block polyetheramides, polymers of acrylic acid, methacrylic acid, acrylamide, itaconic acid, sulfonic acid, elastomers and cellulosic compounds. The elastomer(s) that can be used as binder can be selected from styrene-butadiene (SBR), butadiene-acrylonitrile rubber (NBR), hydrogenated butadiene-acrylonitrile rubber (HNBR).

The electronic conductive material is generally selected from graphite, carbon black, acetylene black, soot, graphene, carbon nanotubes or a mixture thereof. It is used in small amounts, generally 5% or less relative to the sum of the weights of the mixture of active materials, of the binder(s) and of the electronically conductive material.

An ink is prepared by mixing the cathode active materials, the binder(s), generally an electronically conductive material and at least one solvent. The solvent is an organic solvent which can be selected from N-methyl-2-pyrrolidone (NMP), dimethyl formamide (DMF) and dimethyl sulfoxide (DMSO). It can also be selected from cyclopentyl methyl ether (CPME), xylene (o-xylene, m-xylene or p-xylene), heptane, or a ketone-based solvent such as acetone or methyl ethyl ketone (MEK).

The viscosity of the ink is adjusted by varying the amount of solid materials, that is to say the cathode active materials, the binder and the electronic conductive material, or else by varying the amount of solvent.

The ink is deposited on one or both sides of a current collector. This is a current-conducting support, preferably two-dimensional, such as a solid or perforated strip, based on carbon or metal, for example nickel, steel, stainless steel or aluminum, preferably aluminum. The current collector can also be coated on one or both sides with a layer of carbon.

The current collector coated with ink is placed in an oven and the solvent is evaporated. The amount of solid material remaining after evaporation of the solvent can range from 35 to 65% or from 45 to 55% by weight relative to the weight of the ink before drying. The cathode can then be compressed during a calendering step. This step allows to adjust the thickness of the layer of solid material deposited on the current collector. A typical composition of cathode active material after drying is as follows:
from 75 to 97% by weight of the mixture of cathode active materials, preferably from 80 to 90%;
from 1 to 10% by weight of binder(s), preferably from 1 to 5%;
from 1 to 10% by weight of electronically conductive material, preferably from 1 to 5%.

### Preparation of the Anode

The anode is prepared in a conventional manner. It consists of a conductive support used as a current collector which is coated on one or both sides with a layer containing an anode active material and also generally a binder and an electronically conductive material.

The current collector can be a two-dimensional conductive support such as a solid or perforated strip, made of aluminum or an aluminum-based alloy or copper or a copper-based alloy. The current collector can be coated on one or both sides with a layer of carbon.

The anode active material is not particularly limited. It is a material capable of inserting lithium into its structure. It can be selected from lithium compounds, carbon materials such as graphite, coke, carbon black and glassy carbon. It can also be based on tin, silicon, compounds based on carbon and silicon, compounds based on carbon and tin or compounds based on carbon, tin and silicon. It can also be a lithium oxide of titanium such as Li₄Ti5O₁₂ or a niobium titanium oxide such as TiNb₂O₇. It can also consist of metal lithium or of a lithium alloy with one or more chemical elements.

The anode binder can be selected from the following compounds, taken alone or as a mixture: polyvinylidene fluoride (PVDF) and its copolymers, polytetrafluoroethylene (PTFE) and its copolymers, polyacrylonitrile (PAN), poly(methyl)- or (butyl) methacrylate, polyvinyl chloride (PVC), poly(vinyl formal), a polyester, block polyetheramides, polymers of acrylic acid, methacrylic acid, an acrylamide, itaconic acid, sulfonic acid, elastomers and cellulosic compounds.

The electronic conductive material is generally selected from graphite, carbon black, acetylene black, soot, graphene, carbon nanotubes or a mixture thereof. It is generally used at a rate of 7% or less with respect to the sum of the weights of the mixture of anode active material, of the binder and of the electronic conductive material.

Lithium-Ion Cell:

The lithium-ion cell is manufactured in a conventional manner. At least one cathode, at least one separator and at least one anode are superimposed. The assembly can be rolled up to form a cylindrical electrochemical bundle. The invention is not limited to the manufacture of cells of cylindrical format. The format of the cell can also be prismatic or of the pouch type. The electrodes can also be stacked to form a planar electrochemical bundle. A connection part is fixed on an edge of the cathode not covered with active material. It is connected to a current output terminal. The anode can be electrically connected to the container of the cell. Conversely, the cathode can be connected to the container of the cell and the anode to a current output terminal. After being inserted into the container of the cell, the electrochemical bundle is impregnated with electrolyte. The cell is then closed tightly. The cell can also be conventionally equipped with a safety valve causing the container of the cell to open in the event that the internal pressure of the cell exceeds a predetermined value.

The electrolyte can be liquid and comprise a lithium salt dissolved in an organic solvent. This lithium salt can be selected from lithium perchlorate LiClO₄, lithium hexafluorophosphate LiPF₆, lithium tetrafluoroborate LiBF₄, lithium hexafluoroarsenate LiAsF₆, lithium hexafluoroantimonate LiSbF₆, lithium trifluoromethanesulfonate lithium LiCF₃SO₃, lithium bis(fluorosulfonyl)imide Li(FSO₂)₂N (LiFSI), lithium trifluoromethanesulfonimide LiN(CF₃SO₂)₂(LiTFSI), lithium trifluoromethanesulfone methide LiC(CF₃SO₂)₃(LiTFSM), lithium bisperfluoroethylsulfonimide LiN(C₂F₅SO₂)₂(LiBETI), lithium 4,5-dicyano-2-(trifluoromethyl) imidazolide (LiTDI), lithium bis(oxalatoborate) (LiBOB), lithium difluoro(oxalato)borate (LIDFOB), lithium tris(pentafluoroethyl)trifluorophosphate LiPF₃(CF₂CF₃)₃(LiFAP), lithium difluorophosphate LiPO₂F₂ and mixtures thereof. The electrolyte solvent can be selected from saturated cyclic carbonates, unsaturated cyclic carbonates, linear carbonates, alkyl esters, ethers, cyclic esters, such as lactones. Alternatively, the electrolyte can be solid. It may be a compound which conducts lithium ions, selected for example from oxides which conduct lithium ions and sulfides which conduct lithium ions. The electrolyte can also be a lithium ion conductor polymer, such as polyethylene oxide (PEO), polyphenylene sulfide (PPS) and polycarbonate.

The electrolyte can also be in the form of a gel obtained by impregnating a polymer with a liquid mixture comprising at least one lithium salt and an organic solvent. The separator can be made of a layer of polypropylene (PP), polyethylene (PE), polytetrafluoroethylene (PTFE), polyacrylonitrile (PAN), polyester such as polyethylene terephthalate (PET), poly(butylene) terephthalate (PBT), cellulose, polyimide, glass fibers or a mixture of layers of different natures. The mentioned polymers can be coated with a ceramic layer and/or polyvinylidene difluoride (PVdF) or poly(vinylidene fluoride-hexafluoropropylene) (PVdF-HFP) or acrylates.

### Examples

Different electrochemical cells have been manufactured. They differ in the composition of their cathode. Table 1 indicates the composition of the various cathodes manufactured. In all the mixtures prepared, the weight proportions of LMFP and of lithium oxide of nickel, NMC or NCA, are respectively 85% and 15%. The anode of the cells is metal lithium.

TABLE 1

| | |
|---|---|
| Cell 1 | LMFP + NCA mixture in which the nickel index is 0.80 |
| | (outside the invention) - polycrystalline NCA |
| Cell 2 | LMFP + NCA mixture in which the nickel index is 0.87 - |
| | polycrystalline NCA (according to the invention) |
| Cell 3 | LMFP + NMC mixture in which the nickel index is 0.87 - |
| | NMC is monocrystalline (according to the invention) |
| Cell 4 | LMFP + NMC mixture in which the nickel index is 0.84 - |
| | NMC is polycrystalline (according to the invention) |

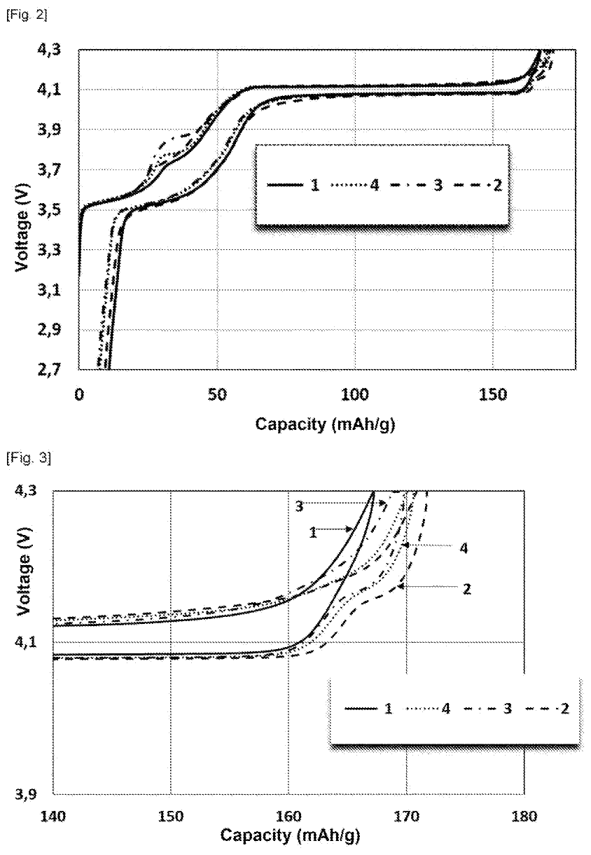

Cells 1 to 4 were cycled at C/20. The charging and discharging profile was shown in FIG. 2. FIG. 3 is an enlargement of FIG. 2 for states of charge close to the end of charge.

It can be seen that the charging profile of the cells 3 and 4 according to the invention has a plateau located between the flat portion and the sudden rise in voltage. The plateau is visible for cells 3 and 4, whether monocrystalline NMC or polycrystalline NMC. The presence of this plateau can be detected using means for measuring the voltage of the cell coupled to electronic means for processing the voltage values measured. The change in concavity of the charging profile is detectable by computer means. The detection of the plateau triggers a signal which warns a user of the imminence of the end of charge.

It is further noted by comparing the charging profile of cells 3 and 4 with that of cell 1 that the addition of monocrystalline or polycrystalline NMC has the effect of increasing the capacity of the cell.

Finally, it can be seen that for the cell 1 whose lithium oxide NCA contains nickel in an amount corresponding to a stoichiometric index of only 0.8, the charging profile does not have a plateau. By comparison, in the case of cell 2 whose lithium oxide NCA contains nickel with a stoichiometric index of 0.87, the charging profile has a plateau. The comparison between the result obtained with example 2 and that obtained with example 1 demonstrates the advantage of using a nickel-rich lithium oxide.

1. A mixture comprising:
more than 50 to 99% by weight of a lithium phosphate of manganese and iron of formula:
LiₓMn_{1-y-z}Fe_{y}M_{z}PO₄ where 0.8≤x≤1.2; 0.5≤1-y-z<1; 0<y≤0.5; 0≤z≤0.2 and M is at least one element selected from the group consisting of B, Mg, Al, Si, Ca, Ti, V, Cr, Co, Ni, Cu, Zn, Y, Zr, Nb and Mo;
1 to less than 50% by weight of at least one lithium oxide of nickel selected from:
i) a lithium oxide of nickel, manganese and cobalt of formula Li_{w}(NiₓMn_{y}Co_{z}Mₜ)O₂ where 0.9≤w≤1.1; 0.80≤x; 0<y; 0<z; 0≤t; M being at least one element selected from the group consisting of Al, B, Mg, Si, Ca, Ti, V, Cr, Fe, Cu, Zn, Y, Zr, Nb, W, Mo, Sr, Ce, Ta, Ga, Nd, Pr and La,
ii) a lithium oxide of nickel, cobalt and aluminum of formula Li_{w}(NiₓCo_{y}Al_{z}Mₜ)O₂ where 0.9≤w≤1.1; 0.83≤x; 0<y; 0<z; 0<t; M being at least one element selected from the group consisting of B, Mg, Si, Ca, Ti, V, Cr, Mn, Fe, Cu, Zn, Y, Zr, Nb, W, Mo, Sr, Ce, Ga, Ta, Nd, Pr and La, and
iii) a mixture of said lithium oxide of nickel, manganese and cobalt with said lithium oxide of nickel, cobalt and aluminum.

2. The mixture according to claim 1, wherein said at least one lithium oxide of nickel is monocrystalline.

3. The mixture according to claim 1, wherein said at least one lithium oxide of nickel is in the form of particles whose size distribution is characterized by a volume median diameter Dv₅₀ less than or equal to 7 m, preferably ranging from 2 to 6 μm, the median diameter being measured on particles not forming part of an agglomerate of particles.

4. The mixture according to claim 1, comprising:
from 60 to 90% by weight of lithium phosphate of manganese and iron;
from 10 to 40% by weight of said at least one lithium oxide of nickel.

5. The mixture according to claim 4, comprising:
from 70 to 80% by weight of lithium phosphate of manganese and iron;
from 20 to 30% by weight of said at least one lithium oxide of nickel.

6. The mixture according to claim 1, wherein, in the lithium oxide of nickel, the index x of the nickel ranges from 0.84 to 0.90.

7. The mixture according to claim 1, wherein, in the lithium oxide of nickel, the index x of the nickel is less than or equal to 0.98 or less than or equal to 0.90.

8. The mixture according to claim 1, wherein, in the lithium phosphate of manganese and iron, the index 1-y-z of manganese ranges from 0.6 to less than 1.

9. An electrochemical cell comprising:
at least one anode,
at least one cathode comprising the mixture according to claim 1.

10. A method for detecting the end of charge of a lithium-ion electrochemical cell, said method comprising the steps of:
a) providing an electrochemical cell according to claim 9,
b) charging the cell,
c) for a state of charge of the cell greater than approximately 70%, calculating at periodic or predetermined instants the value of the derivative of the voltage with respect to time dV/dt,
d) sending a signal indicating the imminence of the end of charge if the value of the derivative dV/dt is lower than a predetermined threshold.
